(19) United States
(12) Patent Application Publication
(10) Pub. No.: US 2019/0029334 A1
(43) Pub. Date: Jan. 31, 2019

(54) BRA WITHOUT BACKSTRAP FOR WEARING WITH BACKLESS GARMENTS

(71) Applicant: MJ & CO, Paris (FR)

(72) Inventor: Stéphanie WOLFF, Paris (FR)

(73) Assignee: MJ & CO, Paris (FR)

(21) Appl. No.: 15/563,517

(22) PCT Filed: Apr. 4, 2016
(86) PCT No.: PCT/FR2016/050759

§ 371 Date: Sep. 29, 2017

(30) Foreign Application Priority Data
Apr. 2, 2015 (FR) 1552858

(51) Int. Cl. A41C 3/00; A41F 15/00; A41C 3/12; A41B 9/04; A41B 9/08; A41C 3/06

(52) U.S. Cl. CPC A41C 3/0078; A41F 15/002; A41C 3/12; A41B 9/04; H04B 5/0062; A41C 3/06; A41C 3/005; A41C 3/0028; A41B 2400/38; A41B 9/08

(57) ABSTRACT

A bra without a backstrap, includes two cups joined together laterally, each cup having an upper edge and a lower edge which are provided respectively with a shoulder strap and with a tightening strap and an external lateral edge connecting the upper and lower edges. The bra includes a connecting element connecting the tightening strap to the cup, the connecting element extending under the cup and having a triangle-shaped arrangement, two of the vertices of the triangle constituting points of connection of the element to the lower edge of the cup, the third vertex constituting a point of connection of the element to the tightening strap, the connecting element being arranged in relation to the cup such that the tightening strap in the vicinity of the point of connection extends in a direction that diverges from the horizontal plane at an angle of between 45° and 90°.

The invention relates to a backless bra for wearing with backless garments such as wedding gowns, evening dresses or prêt-á-porter clothes.

### STATE OF THE ART

A bra is known from U.S. Pat. No. 3,411,508, which comprises a pair of laterally interconnected cups, with a pair of upper straps and a pair of lower straps extending downwards from the bra. Each lower strap extends from a point immediately under the lower edge of the cup which it is associated with, and ends in fastening means to enable the fastening thereof to a belt of another garment. The upper straps are respectively fastened to the upper edge of the cup at one of their ends, and to an external lateral extension of the cup at the other end.

The bra of the aforementioned patent, however, has several disadvantages.

First, it does not provide a totally satisfactory solution in that it does not guarantee a completely invisible appearance when worn with dresses with backs cut down to the small of the back. As a matter of fact, the proposed bra has to be used with an accessory or the belt of a complementary clothing placed around the waist to enable the fastening of the lower straps. If it is worn with a dress with a back cut down to the small of the back, the accessory remains visible.

Moreover, the supporting quality of the bra depends on the quality and support of the accessory or garment whereon the lower straps are fixed, but also on the support thereof. Now, when it is not close-fitting enough, for example, to the person's size, the accessory can move, or even slightly ride up by the action of the lower straps. The tension exerted by these is thus lessened, such that the bra is no longer kept sufficiently pressed against the breast and a loosening of the bottom of the cups can be observed. Besides, the person wearing the bra can also have a feeling of discomfort.

In addition, the presence of lateral extensions which are attached to the external lateral edges of each cup, which take the form of a piece of fabric, having a width substantially equal to the height of the cup, remains visible under the user's armpits, under some clothing also having large cuts under the armpits.

The invention aims at remedying these problems by providing a backless bra ensuring a superior quality support of the breast and a comfortable feeling for the person wearing the bra while providing maximum invisibility thereof.

### OBJECT OF THE INVENTION

For this purpose, and according to a first aspect, the invention provides a bra without a backstrap comprising two cups joined together laterally, with each cup comprising an upper edge and a lower edge which are provided respectively with a supporting shoulder strap and a tightening strap as well as an external lateral edge connecting the upper and lower edges, characterized in that the bra comprises a connecting element connecting the tightening strap to the cup, with said connecting element extending under the cup and having a triangle-shaped arrangement, with two of the vertices of the triangle constituting the points of connection of the element to the lower edge of the cup, with the third vertex constituting a point of junction of the element to the tightening strap, with the connecting element 8, 9 being arranged in relation to the cup 2, 3 so that the tightening strap 6, 7 in the vicinity of the point of junction 6C, 7C, extends in a direction that diverges from the horizontal plane at an angle between 45 degrees and 90 degrees.

The presence of a thus configured connecting element makes it possible to keep the lower part of the cups (low cups) pressed on the person's breast and thus to prevent any loosening of the cups, while offering an optimal degree of inclination making it possible to direct the tightening straps as low as possible in the back.

The total absence of external lateral cup extension on the external lateral edge of each cup replaced, according to the invention, by a cup side edge free of any piece of fabric attached along the length of said edge, and comprising instead a discreet fastener for a supporting shoulder strap, enables the bra according to the invention to remain invisible under clothing having large cuts under the armpits.

The combination of the presence, from the lower edge of each cup, of the connecting element, and of the connection of the supporting shoulder strap on the free side edge of the cup helps supporting the wearer's breast while remaining a discreet model.

The points of connection of the connecting element are advantageously located on the lower edge of the associated cup, between the external lateral edge and the midpoint of the latter.

The points of connection are advantageously located at a minimum distance from each other equal to or greater than 2 cm and/or equal or less than 7 cm, and/or preferably between 3.5 and 5 cm.

The connecting element is advantageously so dimensioned that the point of junction is positioned at a distance from the lower edge of the cup equal to or greater than 20 cm and/or equal to or less than 45 cm and/or preferably between 28 and 38 cm. In the present invention, the distance is defined perpendicularly to the lower edge of the cup. According to an alternative embodiment, this distance ranges from 1 to 20 cm, preferably from 5 to 15 cm and more preferably, from 5 to 8 cm.

The connecting element is advantageously arranged with the cup so that the tightening strap, in the vicinity of the point of junction, extends in a direction that diverges from the horizontal plane at an angle between 45 degrees and 90 degrees and preferably between 70 degrees and 90 degrees.

According to a particular configuration, the connecting element consists of a preferably elastic flange extending under the cup, with the ends of said flange forming the fastening points. The tightening strap is advantageously connected to the flange by means of a fastener capable of sliding along said flange.

According to another configuration, the connecting element consists of a piece of stretch fabric bounded, between the point of junction and each one of the points of connection by an elasticized border.

Each tightening strap advantageously comprises, at its free end, means for mutual fastening. “Free end” means the end of the strap opposite the end fastened to the connecting element.

In a particular embodiment, the tightening strap connects the upper edge of the cup to the external lateral edge of the same cup. The advantage of this configuration is that, when the bra is worn, the supporting shoulder strap goes around the arm, leaving the shoulders bare. In an alternative embodiment, the supporting shoulder strap connects the upper edge of each one of the cups. It should be understood that, in the first embodiment, the bra has two supporting shoulder straps, with each one connecting the upper edge to the external lateral edge of the cup which it is associated to, so as to go around the arm, while in the second embodiment, the bra has a single supporting shoulder strap, the latter passing behind the neck of the person wearing the bra.

The tightening strap and/or the supporting shoulder strap advantageously is (are) removable. As regards the tightening strap, it may be provided to be removable either at its junction with the connecting element, or at the fastening points (in this case, the connecting member is removable) or both.

The upper edge 20, 30, and the external lateral edge 22, 32 of each cup 2, 3 and/or the upper side 40 of the connecting element 8, 9 advantageously are (is) respectively provided with a row of at least two fasteners (or hooks) capable of receiving a matching fastener provided at each end of the supporting shoulder strap. The presence of these rows of fasteners on the external lateral edge and/or the upper edge of the cup makes it possible to adjust the position of the supporting shoulder strap (s) and to adapt same to the neckline of the clothing worn.

According to other advantageous characteristics of the invention:
the fastener of the end of a supporting shoulder strap is provided with a safety hook comprising a fastening portion at the end of the supporting shoulder strap, two openings for the passage of a free portion of the fastener, separated from one another by a portion of a loop whereon the fastening portion rests, and two retaining tabs of the fastening portion.
the upper edges of the cups are provided with a cut opening on an inter-breasts part of the bra, with the inter-breasts part having a filiform shape and defining with the two cuts of the two cups a cleavage-forming free space or neckline.

The invention also relates to a lingerie set, consisting of the bra above, and a panty comprising loops for the passage of the tightening straps. The panty may be briefs, a thong, a boxer, a skirt, a garter-belt, a girdle, tights or any other type of underwear worn on the lower part of the body.

Ideally, the panty is of the hipster type.

The panty preferably comprises loops all along its upper periphery.

The panty particularly has a shaping or sculpting effect, specifically on the wearer's buttocks.

The invention also relates to a bra sales kit gorge above, comprising said bra provided with an initial set of removable supporting shoulder straps and tightening straps, and at least one extra set of two removable supporting shoulder straps and two removable supporting shoulder straps to be substituted to the initial set, having a texture and/or a color and/or an opacity and/or a length and/or a width different from those of the initial set of supporting shoulder straps and tightening straps for the bra.

Ideally, the sales kit will comprise at least two bras of different sizes, and one identifier of the RFID chip or QR code type capable of providing access to a remote data medium through a mobile terminal connected to a communication network, providing access to instructions for use of the brassiere according to the invention (optionally combined with the panty), to commercial information (price, point of sale, availability of products, opportunities of online shopping . . . ).

### BRIEF DESCRIPTION OF THE FIGURES

Other objects and advantages of the invention will appear upon reading the following description while referring to:

FIG. 1 which shows a schematic front view of a brassiere according to a particular embodiment of the invention, with the bra shown being worn by a person

FIG. 2 which shows a schematic view of the internal face of a bra in a second embodiment of the invention.

FIGS. 3 and 4 respectively show an alternative solution, wherein the supporting shoulder straps are fastened to the side edges of the cups and an alternative solution wherein they are fastened on the upper side of the connecting element

FIG. 5 a to d show the fastening of the ends of the supporting shoulder straps to internal rings of the cup using a safety hook,

FIGS. 6 to 8 show alternative embodiments: with rings along the upper and side edges of the cups, and along the upper side of the connecting element (FIG. 6), with front cuts having two different shapes (FIGS. 7 and 8)

FIGS. 9 to 11 show three alternative embodiments of a lingerie set according to the invention worn by a user, and seen from the front and the back (with the bra alone in FIG. 9, with combined bra and skirt (FIG. 10), with shorts or a boxer (FIG. 11),

FIGS. 12 and 13 respectively show a bra presentation kit according to the invention and its presentation document

FIGS. 14 to 17 show the possible dimensions of different sizes of the bra according to the invention.

### DETAILED DESCRIPTION OF THE FIGURES

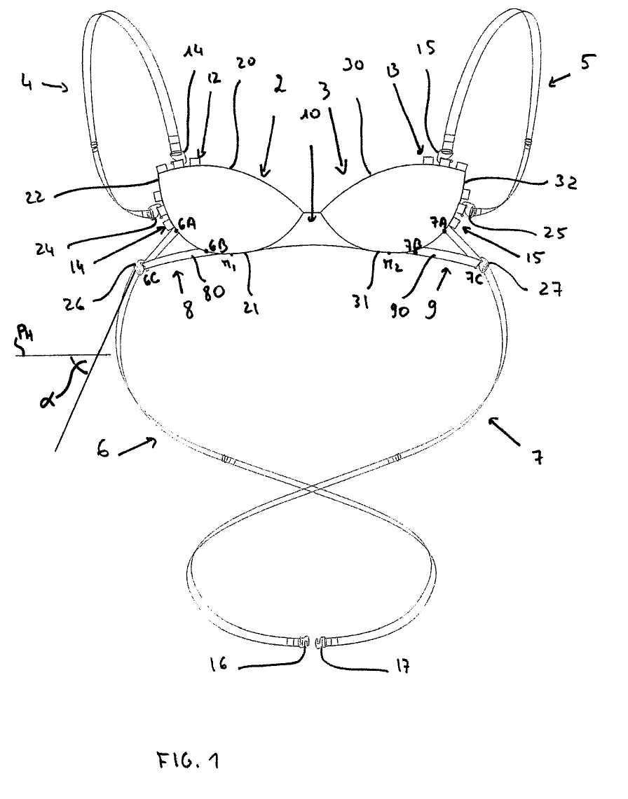

FIG. 1 describes a bra 1 comprising two cups 2, 3 laterally interconnected by an inter-breasts part 10 and two pairs of removable straps, with one pair constituting tightening straps 6, 7 (lower straps), the other pair constituting shoulder straps 4, 5 (upper straps).

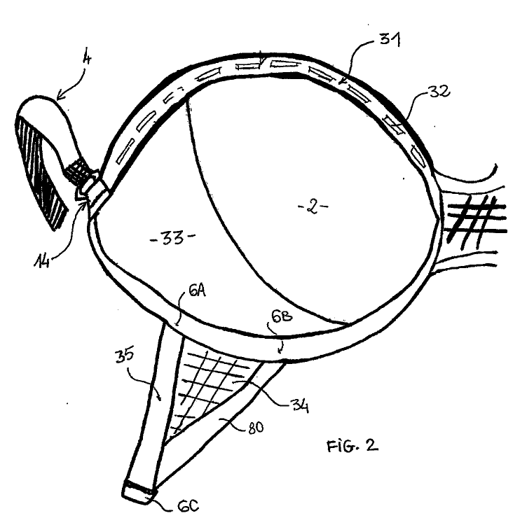

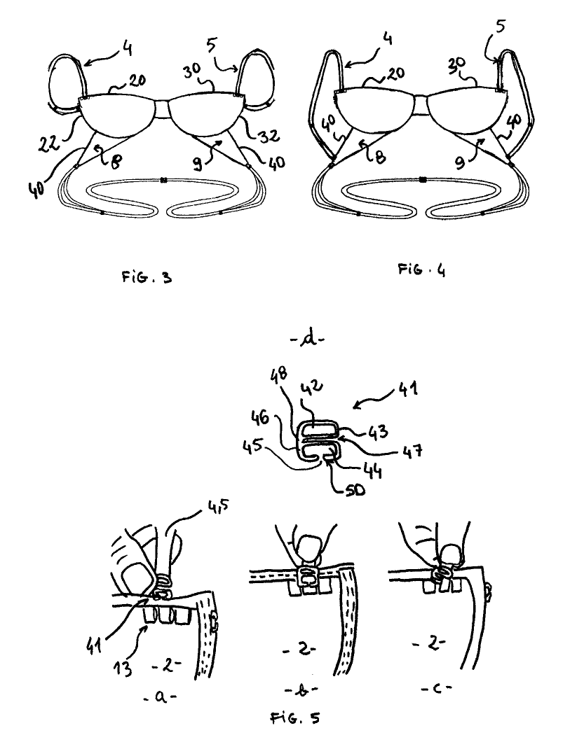

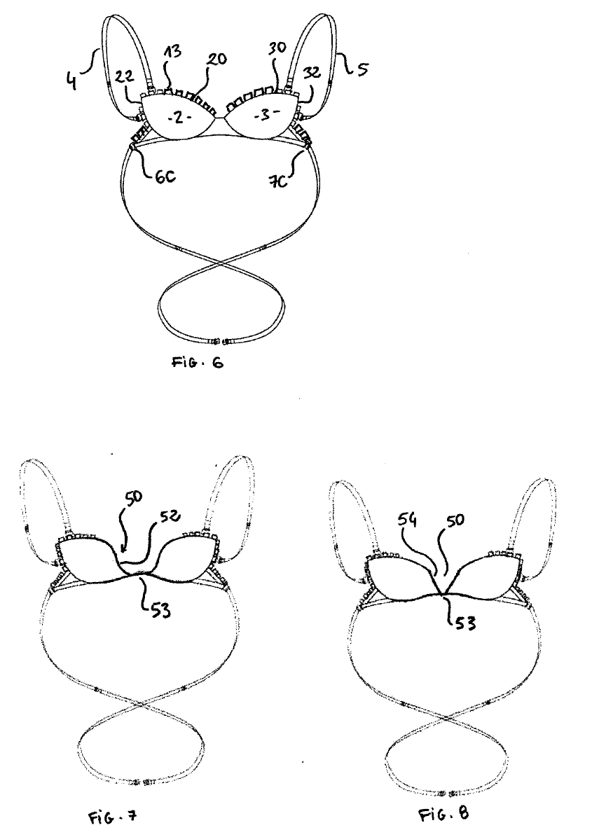

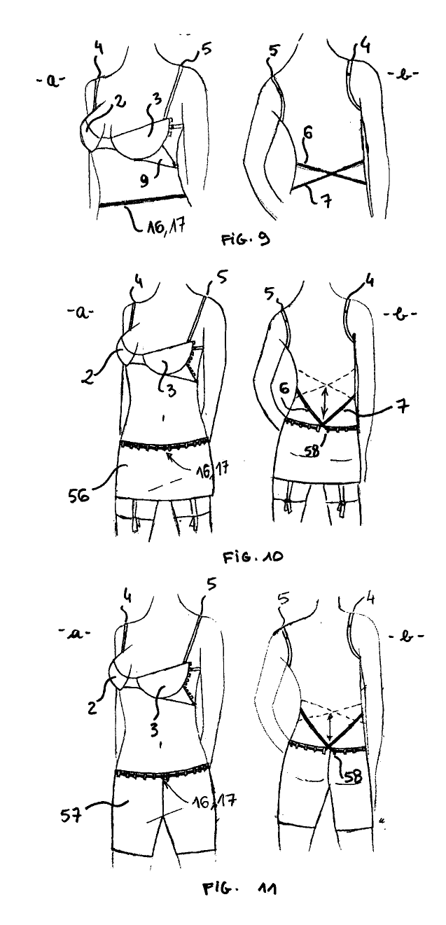

More particularly, each cup 2, 3 is delimited by an upper edge 20, 30, a lower edge 21, 31 and an external lateral edge 22, 32 connecting the upper and lower edges. The upper edge 20, 30 of each cup 2, 3 is provided with a supporting shoulder strap 4, 5, whereas the lower edge 21, 31 is provided with a tightening strap 6, 7. The lower edge is sized so as to match the breast fold of one breast. Advantageously, for cups intended for larger breasts, according to FIG. 2, each cup 3 will include support reinforcement 33. This reinforcement may be a half-moon 33 extending at the lower part of cup 2. In the example shown, the half-moon is made of a locknit or tulle portion attached to the inner face of the cup. According to one embodiment, not shown, this reinforcement may take the form of a rigid half-moon integrated to the material the cup is made of, for instance plastic, and can be configured in a shape enhancing the reinforcing function.

The supporting shoulder straps 4, 5, advantageously transparent and adjustable in length, are so arranged as to connect the upper edge 20, 30 of the cup 2, 3 associated with the external lateral edge 22, 32 of the same cup. As they are directly fastened to the external lateral edge of the associated cup, they go round the arm of the person wearing the bra 1, thereby clearing the shoulders and particularly the shoulder blades to the full.

As for the tightening straps 6, 7, advantageously transparent and adjustable in length, they are intended to cross at the lower back, preferably at the small of the back, and fastened to each other at the front, by means of mutual fastening means 16, 17 provided at their free ends.

Each tightening strap 6, 7 is connected to a cup 2, 3 by a connecting element 8, 9, which extends under the corresponding cup and has a triangle-shaped arrangement, with two of the vertices of the triangle constituting the points of connection 6A, 6B, 7A, 7B of the element to the lower edge of the cup, with the third vertex constituting a point of junction 6C, 7C of the element with the tightening strap 6, 7.

In the illustrated embodiment, the connecting element 8, 9 consists of a flat flange 80, 90, advantageously elasticized, so arranged as to extend under the associated cup 2, 3, with its two ends being fastened to the lower edge 21, 31 of said cup. The tightening strap 6, 7 is held on the associated flange 80, 90 by means of a fastener 26, 27 which is provided at the end of said strap. The ends of each flange 80, 90 thus constitute the fastening points 6A, 6B, 7A, 7B to the associated cup 2, 3 whereas the point of junction 6C, 7C corresponds to the fastening point 26, 27 of the associated tightening strap 6, 7.

In the example shown, the fastener 26, 27 is a safety hook. The advantage of such a fastener (a hook which can slide along the flange) is that, when the bra 1 is worn, and the tightening straps 6, 7 are attached together by their free ends 16, 17, the end with the fastener 26, 27 self-adjusts, adopting an optimal position relative to the person's morphology. Obviously, of course, the invention is not limited to this type of fastening and any other suitable means enabling a releasable fastening may be provided without departing from the scope of the invention.

Advantageously, each flange 80, 90 is attached to the associated cup 2, 3 so as to have two separate fastening points (ends) located in the outer half of the lower edge 21, 31. More particularly, the points of connection 6A, 6B, 7A, 7B of the flange 80, 90 are on the lower edge 21, 31 of the associated cup 2, 3, between the external lateral edge 22, 32 and the midpoint M1, M2 of the latter. In the illustrated embodiment, one of the fastening points 6B, 7B is located near the midpoint M1, M2, whereas the other one 6A, 7 A is in the vicinity of the junction between the lower edge 21, 31 and the external lateral edge 22, 32 of the cup. Advantageously, the fastening points 6A, 6B are arranged at a distance from one another of the order of 3.5 to 5 cm. The point of junction 6C, 7C is in turn positioned at a distance from the lower edge of the cup between 28 and 38. As the fastening point of the cup tightening strap is offset, the back is cleared further down.

Advantageously, each flange 80, 90 is arranged with the cup 2, 3 being so associated that the associated tightening strap 6, 7 extends, in the vicinity of the point of connection, in a direction that diverges from the horizontal plane at a maximum angle of 90 degrees. 90 degree spacing with the upper horizontal plane would bring about a loosening of the cup 2, 3 from the breast of the person wearing the bra 1. Furthermore, in order to prevent the tightening straps 6, 7 from being visible with a backless garment, it is advantageous to provide an arrangement of the flange 80, 90 with the cup 2, 3 being so associated that each flange 80, 90 extends in a direction that diverges from the horizontal plane at an angle of at least 45 degrees. However, and although not shown, a preferred arrangement of the flange 80, 90 will be the one ensuring a spacing of the flange 80, 90 relative to the horizontal plane between 70 and 90 degrees.

In the illustrated embodiment, each flange 80, 90 consists of a single strip, with the latter being folded at the junction 6C, 7C with the associated tightening strap 6, 7. According to a non-illustrated alternative embodiment, a flange consisting in separate strips connected to one another at their free ends may be provided. “Free end” means the ends opposite the ends of the strips attached to the cup 2, 3.

In the embodiment described above, the supporting shoulder straps 4, 5 and the tightening straps 6, 7 are removable. Obviously, the invention is not limited to this configuration and the tightening straps 6, 7 and/or the supporting shoulder straps 4, 5 may be provided not to be releasable from the cups which they are associated with. Furthermore, the tightening straps 6, 7 consist of two separate strips. According to one alternative embodiment, the tightening straps 6, 7 may be provided as a single strip. It should be understood in this case that the strip must first be placed around the person's torso to be then fastened to the connecting elements 8, 9 at its ends and adjusted to the person wearing the bra.

According to another embodiment of the invention, the connecting element 8, 9 can be provided to be the very end of the tightening strap 6, 7, with the connecting element and the associated cup respectively comprising mutual fastening means enabling a removable fastening of the connecting element to the cup concerned.

According to the alternative solution shown in FIG. 2, the connecting element 8, 9 is formed by a piece of stretch fabric 34 delimited between the point of junction 6C and each one of the points of connection 6A, 6B, by an elasticized border 35.

In the embodiment illustrated in FIG. 1, each supporting shoulder strap 4, 5 is removably fastened to the cup 2, 3 at its ends, with one end being fastened to the upper edge 20, 30 of said cup, with the other one being fastened to the external lateral edge 22, 32. For this purpose, the ends of the supporting shoulder strap 4, 5 are provided with fasteners 14, 15, 24, 25 like safety hooks adapted to engage in rings (or fastening loops) 12, 13, 14, 15 provided for this purpose at the upper edge 20, 30 and on the external lateral edge 22, 32 of the associated cup 2, 3. In the example illustrated, the upper edge and the external lateral edge are respectively provided with three fastening loops or rings. This makes it possible to adapt the positioning of the upper straps to the cut of the garment but also to the morphology of the person wearing the garment. Of course a different number of fastening loops can be provided within the scope of the invention.

Advantageously, the fastening loops 14, 15 located on the upper edge 20, 30 of the cup 2, 3 are so placed as to be as close as possible to the junction between the upper edge and the side edge of the cup 2, to ensure the invisibility of straps. According to the embodiment of FIG. 2, the rings of the upper edge of the cup are replaced by a flat binding elastic 31 with integrated buttonholes 32 along the top edge of the cup on the inner surface thereof, with such buttonholes composing slots 32 in each of which the safety hook 14 of the support strap 4 can engage. The advantage of this embodiment is to make the system for fastening the shoulder strap on the top edge of the cup even less visible.

As indicated above, the supporting shoulder straps 4 and 5 are fastened on the one hand by one of their ends on the upper edge 20, 30 of the corresponding cup and on the other hand, either:
as also mentioned above, at the side edge 22, 32 of the corresponding cup (FIG. 3)
or, in accordance with an interesting embodiment, on the upper edge 40 of the connecting element 8, 9. Such alternative solution may be more suitable for some clothing, or more comfortable than that of FIG. 3 to some users.

According to FIGS. 5a, 5b, 5c, the fastening of the supporting shoulder strap 4, 5, is even more secured when using internal rings 13 fastened by a rear face, on the inner face of the shell 2, with the front face of the ring defining with the secured rear face an opening for the passage of a hook and via a secure hook 41, which comprises, as best seen in FIG. 5d:
an upper opening for the passage and fastening of said strap 4, 5, delimited by a closed loop 43,
a lower opening 44 for the passage of the ring 13, delimited by an open loop 46 through a slot 45 in communication with the lower opening 44, with an open loop 46 defining two retaining tabs 50 on either side of the slot.
an intermediate opening 47 defined by the lower edge of the closed loop 43 and the upper edge of the open loop 46, with the two loops 43, 46 being connected by a bridge of material 48, with the edges delimiting the intermediate opening, i.e. a C-shaped passageway.

The fastening of the secured hook 41 of a strap on a ring 13 is provided by passing the front side of the ring 13 through the intermediate opening 47 of the secured hook 41 (FIG. 5c) and then bringing the retaining tabs 50 to the front of the ring 13 (FIG. 5b).

The alternative embodiment of FIG. 6 is designed to ensure the greatest adaptability to the various morphologies of users with the possibility that:
the whole length of the upper edge 20, 30 of each cup can optionally be provided with (internal or external) rings,
the whole length of the external lateral edge 22, 32 of each cup can optionally also be provided with (external or internal) rings
the whole length of the upper side 40 of the connecting element 8, 9 (between its fastening to the cup and the corresponding junction 6C, 7C) can optionally be equipped.

The alternative solutions of FIG. 7 and make it possible to define a front neckline 50 enabling to wear garments with a front cleavage through cuts provided on the upper edges 20, 30, of the two cups 2, 3 and eliminating the inter-breasts part 10, which is replaced by a finer element 53. In the example of FIG. 7, the cut 52 has a curvilinear shape (a kind of inverted “S”), whereas the cut 54 shown in FIG. 8 is straight and forms a V-shaped cleavage with the cut of the adjacent cup.

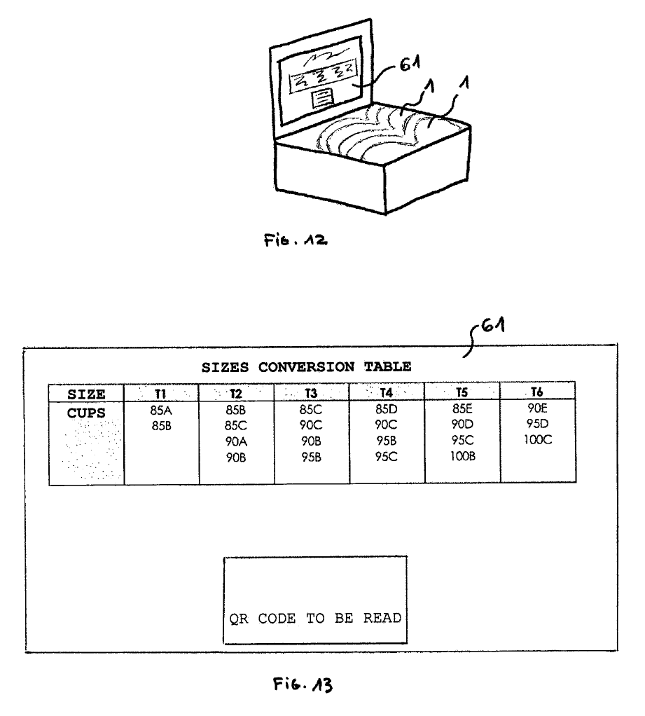

FIGS. 9 to 11 show the positioning of the bra on a user, in various embodiments:
the first one 9 wherein the bra is used alone, i.e. independently of any panty such as briefs or boxers and enables the passage of tightening straps 6, crossing at the small of the back of the wearer (FIG. 9b) and coming back to the front to be secured together by means of hooks 16, 17 at the navel of the wearer,
the second and third ones (FIGS. 10 and 11) wherein the bra is used in combination with a possibly shaping or sculpting hipster type of panty (a skirt for the alternative embodiment of FIG. 10 made of stretch material, or leggings 57 for the alternative solution of FIG. 11), the upper edge of which is positioned about 10 cm below the user's navel (and small of the back), and which is provided with external loops 58 for the passage of tightening straps 6, 7. These straps 6, 7 cross just above the upper edge of the hipster panty and fit between two central back loops, in order to be positioned externally along the upper edge of the panty 56, 57, while passing through the other loops to be fastened together by the hooks 16, 17 on the front of the panty 56, 57. Using hipster panties in combination with the bra according to the invention makes it possible to further lower the shoulder straps crossing place at the back of the user (by about 10 cm) and thus to wear garments having a deeper cleavage at the back.

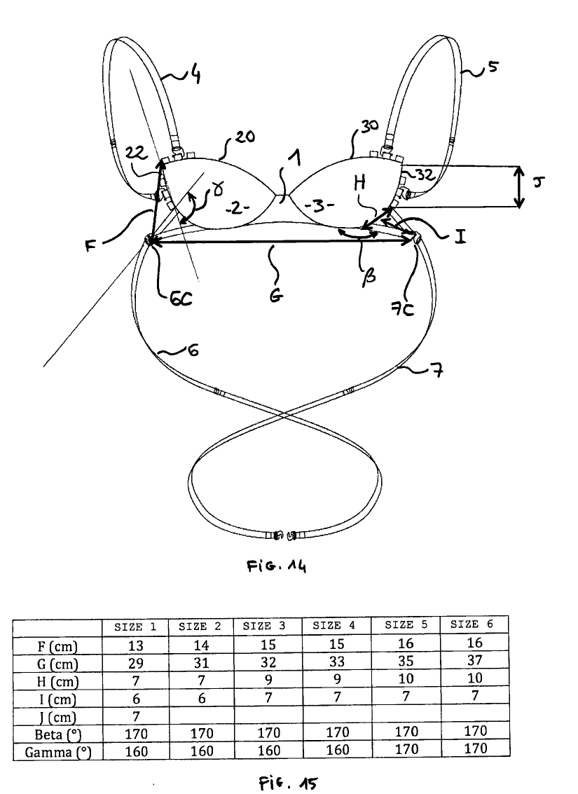

FIG. 12 illustrates the packaging of the bra according to the invention, in different sizes to provide the one fitting a user. This box may comprise 6 different sizes of bra and a document stuck on the inside of the box lid, which will establish the correspondence between the sizes of the models of the bra according to the invention (size 1 to size 6) and those of conventional bras (85A to 100C) according to FIG. 13. This document may be provided with a QR CODE to be read by a mobile terminal equipped with an appropriate application, in order to visualize an explanatory film on the positioning of the bra according to the invention (fastening of the hooks, adjustment of the straps).

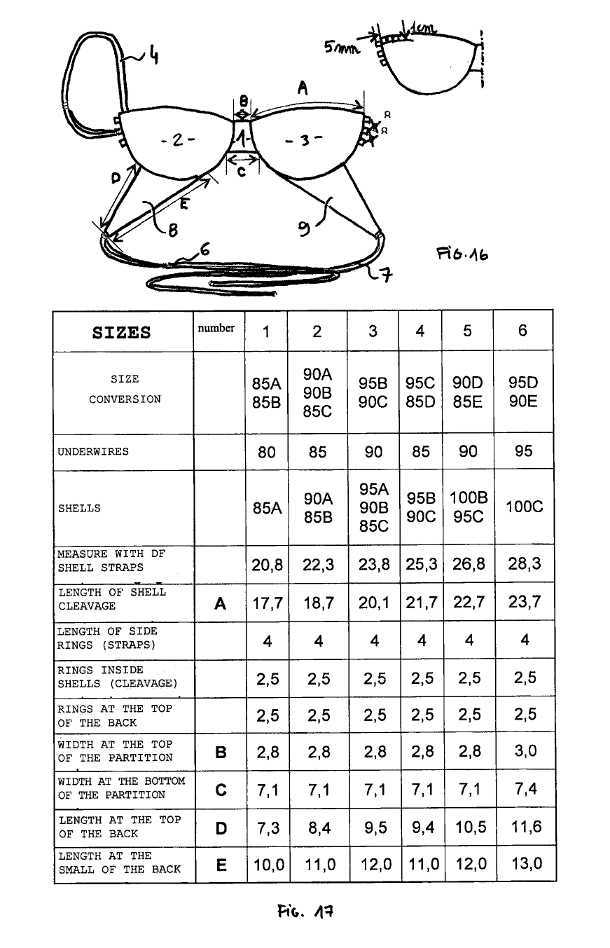

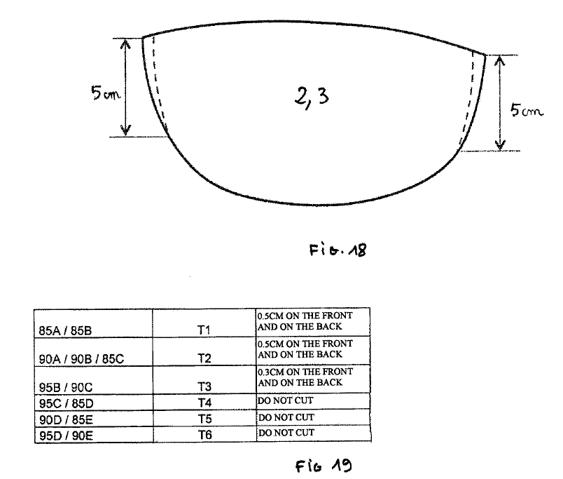

FIGS. 14 to 17 illustrate various important dimensions of the bra according to the invention, depending on the sizes provided.

FIGS. 18 and 19 illustrate the adaptation of conventional bra shell cups to form the shells of the brassiere according to the invention and mainly consisting of a cut in the sides of each cup along a substantially curved profile having a width between 0.3 and 0.5 cm and a height of 5 cm.

The invention is described above as an example. It should be understood that the person skilled in the art can provide for various embodiments of the invention without departing from the scope thereof.

1. A bra without a backstrap comprising two cups joined together laterally, with each cup comprising an upper edge and a lower edge which are provided respectively with a supporting shoulder strap and a tightening strap, and an external lateral edge connecting the upper and lower edges, a connecting element connecting the tightening strap to the cup, with the connecting element extending under the cup and having a triangle-shaped arrangement, with two vertices of the triangle constituting points of connection of the element to the lower edge of the cup, with a third vertex constituting a point of junction of the element to the tightening strap, with the connecting element being arranged in relation to the cup so that the tightening strap in a vicinity of a point of junction, extends in a direction that diverges from a horizontal plane at an angle between 45° and 90°, and the supporting shoulder strap connecting the upper edge of the cup to the external lateral edge of the same cup or to the upper side of the connecting element.

2. The bra according to claim 1, wherein the points of connection of the connecting element are located on the lower edge of the cup associated therewith, between the external lateral edge and a midpoint of the latter.

3. The bra according to claim 1 wherein the points of connection are located at a minimum distance from each other of 3.5 to 5 cm.

4. The bra according to claim 1, wherein the connecting element is dimensioned such that the point of junction is positioned at a distance from the lower edge of the cup between 1 and 38 cm.

5. The bra according to claim 1, wherein the connecting element is arranged in relation with the cup such that the tightening strap in the vicinity of the point of junction, extends in a direction that diverges from the horizontal plane at an angle between 70 degrees and 90 degrees.

6. The bra according to claim 1, wherein the connecting element comprises a flange extending under the cup, with the ends of the flange forming fastening points.

7. The bra according to claim 6, wherein the tightening strap is connected to the flange by a fastener capable of sliding along the flange.

8. The bra according to claim 6 wherein the flange is elastic.

9. The bra according to claim 1, wherein the connecting element comprises a piece of stretch fabric bounded, between the point of junction and each point of connection, by an elasticized border.

10. The bra according to claim 1, wherein tightening strap comprises, at its free end, means for mutual fastening.

11. The bra according to claim 1, wherein the tightening strap and/or the supporting shoulder strap is/are removable.

12. The bra according to claim 1, wherein the upper edge, and the external lateral edge of each cup and/or the upper side of the connecting element are each respectively provided with a row of at least two fasteners capable of receiving a matching fastener provided at each end of the supporting shoulder strap.

13. The bra according to claim 1, wherein the fastener of the end of a supporting shoulder strap is provided with a safety hook comprising a fastening portion at the end of the supporting shoulder strap, two openings for the passage of a free portion of the fastener separated from one another by a portion of a loop, whereon the fastening portion rests, and two retaining tabs of the fastening portion.

14. The bra according to claim 1, wherein the upper edges of the cups are provided with a cut opening on an inter-breasts part of the bra, with the inter-breasts part having a filiform shape and defining with the two cuts of the two cups a cleavage-forming free space or neckline.

15. A lingerie set comprising:
(a) a bra comprising two cups joined together laterally, with each cup comprising an upper edge and a lower edge which are provided respectively with a supporting shoulder strap and a tightening strap, and an external lateral edge connecting the upper and lower edges, a connecting element connecting the tightening strap to the cup, with the connecting element extending under the cup and having a triangle-shaped arrangement, with two vertices of the triangle constituting points of connection of the element to the lower edge of the cup, with a third vertex constituting a point of junction of the element to the tightening strap, with the connecting element being arranged in relation to the cup so that the tightening strap in a vicinity of a point of junction, extends in a direction that diverges from a horizontal plane at an angle between 45° and 90°, and the supporting shoulder strap connecting the upper edge of the cup to the external lateral edge of the same cup or to the upper side of the connecting element; and
(b) a panty comprising loops for the passage of the tightening straps.

16. The lingerie set according to claim 15, wherein the panty is of the hipster type.

17. The lingerie set according to claim 15 wherein the panty comprises loops all along its upper periphery.

18. The lingerie set according to claim 15, wherein the panty has a shaping or sculpting effect, specifically on the wearer's buttocks.

19. A bra sales kit comprising:
a bra, without a backstrap, comprising two cups joined together laterally, with each cup comprising an upper edge and a lower edge which are provided respectively with a supporting shoulder strap and a tightening strap, and an external lateral edge connecting the upper and lower edges, a connecting element connecting the tightening strap to the cup, with the connecting element extending under the cup and having a triangle-shaped arrangement, with two vertices of the triangle constituting points of connection of the element to the lower edge of the cup, with a third vertex constituting a point of junction of the element to the tightening strap, with the connecting element being arranged in relation to the cup so that the tightening strap in a vicinity of a point of junction, extends in a direction that diverges from a horizontal plane at an angle between 45° and 90°, and the supporting shoulder strap connecting the upper edge of the cup to the external lateral edge of the same cup or to the upper side of the connecting element; and
an initial set of removable supporting shoulder straps and tightening straps, and at least one extra set of two removable supporting shoulder straps and two removable supporting shoulder straps to be substituted to the initial set, having at least one of: a texture, a color, an opacity, a length, and/or a width, different from those of the initial set of supporting shoulder straps and tightening straps for the bra.

20. The kit according to claim 19, comprising at least two bras of different sizes, and an identifier of a RFID chip or QR code type capable of providing access to a remote data medium through a mobile terminal connected to a communication network.
